(19) United States
(12) Patent Application Publication
(10) Pub. No.: US 2011/0064887 A1
(43) Pub. Date: Mar. 17, 2011

(54) MANUFACTURING PROCESS FOR WORKPIECE FOR ELECTROLESS PLATING

(75) Inventors: Manabu OSAMURA, Kariya-shi (JP); Toshihisa Shimo, Kariya-shi (JP); Isami Kato, Kariya-shi (JP); Takashi Yoshida, Kariya-shi (JP); Takeshi Bessho, Toyota-shi (JP)

(73) Assignees: KABUSHIKI KAISHA TOYOTA JIDOSHOKKI, Kariya-shi (JP); TOYOTA JIDOSHA KABUSHIKI KAISHA, Toyota-shi (JP)

(21) Appl. No.: 12/883,945

(22) Filed: Sep. 16, 2010

(30) Foreign Application Priority Data
Sep. 17, 2009 (JP) 2009-216029

(51) Int. Cl. B05D 3/06; B05D 3/10

(52) U.S. Cl. 427/539; 427/248.1; 427/558

(57) ABSTRACT

A process for manufacturing workpiece whose surface is to be plated by means of electroless plating includes an ozone-processing step, and a superficial-layer removing step. In the ozone-processing step, a workpiece body including resin and having a surface is processed by means of an ozone treatment by brining the workpiece body into contact with a solution including ozone. Thus, a modified layer is formed on the surface of the workpiece body. Then, in the superficial-layer removing step, a superficial layer is removed from the resultant modified layer by applying energy onto the modified layer.

### INCORPORATION BY REFERENCE

The present invention is based on Japanese Patent Application No. 2009-216,029, filed on Sep. 17, 2009, the entire contents of which are incorporated herein by reference.

### BACKGROUND OF THE INVENTION

1. Field of the Invention

The present invention relates to a process for manufacturing workpiece for electroless plating, workpiece which is subjected to electroless plating that is used to form plating coated films on resinous surfaces, for instance.

2. Description of the Related Art

Resinous materials have been expected to be utilized in a wide variety of fields because of such characteristics as being readily molded, exhibiting high degree of freedom in the values of physical properties like strength, and being lightweight. However, the resinous materials have the following disadvantages as well: they are not conductive electrically; and they exhibit low hardness. Accordingly, in order to compensate the disadvantages, compositing the resinous materials with metals have been carried out. For example, as one of methods for giving electric conductivity to resin, a method has been known in which an electrically-conductive coated film, such as a metallic coat, is formed on the surface of resin. Of all the methods for giving electric conductivity to resin, chemical plating (or electroless plating) enables manufacturers to form electrically-conductive coated films conveniently and less expensively, compared with the other methods for forming electrically-conductive coated films. The term, “electroless plating,” refers to methods in which metallic ions in solutions are deposited or precipitated by means of reducing them chemically, thereby forming metallic coated films on the surface of workpiece. In contrast to electrolytic plating in which metallic ions in solutions are precipitated by means of electricity, electroless plating method makes it possible to form metallic coated films even on insulators like resins. Moreover, since it is possible to further subject resinous materials with metallic coated films formed to electrolytic plating, it is feasible to expand the application of the resinous materials furthermore. Consequently, electroless-plating treatments have been used widely for giving electric conductivity and/or metallic gloss to resinous workpieces that are used in the fields like automotive component parts and home electric appliances.

However, plating coated films that are formed by electroless plating might be associated with the following problems: it might take time until the coated films are formed completely; and the coated films might exhibit adherability to resinous workpieces insufficiently. Therefore, pretreatments have been carried out onto resinous workpieces prior to the electroless-plating treatments.

As a pretreatment for improving the adherability, roughening the surface of resinous workpiece has been carried out in general by means of chemical etching that aims at upgrading the adhesion strength between resinous workpiece and plating coated film by means of anchoring effect. However, the roughening method by means of chemical etching might be associated not only with the lowered surface flatness but also with waste-liquid disposable issues, because chemical etching uses toxic deleterious substances, such as chromic acid, permanganic acid and sulfuric acid.

Hence, as disclosed in Japanese Unexamined Patent Publication (KOKAI) Gazette No. 2005-36,292, Japanese Unexamined Patent Publication (KOKAI) Gazette No. 2005-113,236 and Japanese Unexamined Patent Publication (KOKAI) Gazette No. 2009-24,244, plating coated films are formed by electroless plating after modifying the surface of resinous workpieces by bringing the resinous workpieces into contact with ozone water (or subjecting the resinous workpieces to ozone-water treatments). When a resinous workpiece is brought into contact with ozone water, ozone oxidizes the surface of the resinous workpiece to cut molecular chains like double bonds in the surface. As a result, polar groups, such as the OH group, CO group and COOH group, generate in the surface. Thus, it is possible to form a plating coated film, which exhibits good adhesion strength, by carrying out electroless plating onto the resinous workpiece that has many polar groups in the surface. Moreover, the surface of the resinous workpiece is provided with a layer that has pores whose sizes are on the level of nanometers or less, because the ozone water permeates into the superficial section of the resinous workpiece. Accordingly, when carrying out electroless plating onto the resinous workpiece with such a surface, the plating liquid penetrates down into the pores. Consequently, the superficial section of the resinous workpiece turns into a mixture layer that comprises resin and metal, because the metallic ions deposit or precipitate in the pores. Therefore, the mixture layer can produce nanometer-level anchoring effect between the plating coated film and the resinous workpiece.

Moreover, according to the patent publication gazettes, it has been carried out bombarding or irradiating the resinous workpiece's surface with ultraviolet rays as well as processing the surface with ozone water. It has been said that the bombardment or irradiation of ultraviolet rays can preferably be carried out simultaneously with the ozone-water treatment. In other words, the synergistic action of ultraviolet ray and ozone activates the surface of the resinous workpiece to generate the polar groups much more.

In addition, for the purpose of exposing the polar groups much more on the resinous workpiece's surface like the above-described bombardment or irradiation of ultraviolet rays, it has also been carried out treating the surface of the resinous workpiece with solutions that include alkaline components after processing the surface with ozone water. Depending on the combinations of alkalis and resins to be made use of, however, to use solutions including alkaline components might result in the following problems: the solutions do not dissolve the resinous workpiece at all; or not only the resins have been dissolved in the solutions more than necessary because the resins are likely to be dissolved in the solutions, but also the resinous workpiece itself has been deteriorated. Moreover, the surface treatment for resinous workpiece that uses solutions including alkaline components might degrade the flatness of the workpiece's surface, because the surface treatment is no different from the aforementioned chemical etching.

To summarize the above, activating the surface of resinous workpiece to form polar groups much more thereon has been done conventionally so as only to make the subsequent plating be likely to produce plating coated films that exhibit good adhesiveness to the resinous workpiece's surface. Besides, the adhesive strength of the resulting plating coated films has not been evaluated heretofore when they are left in harsh environments after the plating.

It is possible to closely adhere an electroless-plating coated film on a flat surface of resin by simply processing a resinous workpiece with an ozone-water treatment before carrying out an electroless-plating treatment as having been performed conventionally. However, as a result of subjecting such electroless-plating coated members to a durability test, it was found out that the electroless-plating coated films had come off from the resinous workpieces or materials (or substrates) noticeably when the coated members were left in high-temperature and high-humidity environments. However, the coated members have been required to show such reliability that they are still serviceable even in environments that are likely to be high temperatures and high humidities.

### SUMMARY OF THE INVENTION

Therefore, it is an object of the present invention to provide a process for manufacturing workpiece for electroless plating, manufacturing process which makes it possible to improve the adhesion strength between resinous workpiece and electroless-plating coated film, that is, manufacturing process which can eventually inhibit the decline of adhesion strength that is likely to occur in high-temperature and high-humidity environments.

The inventors of the present invention assessed electroless-plating coated members, which were made by subjecting resinous workpieces to electroless plating after treating the resinous workpieces with ozone water, from various viewpoints. As a result, the inventors could ascertain the fact that the come-off of electroless-plating coated film, which occurs in high-temperature and high-humidity environments, often results from destructions that start at the superficial layer of resinous workpiece (i.e., a mixture layer of resin and metal), not occurring at the boundary face between resinous workpiece and electroless-plating coated film at all. The inventors believed that the phenomenon causes resinous workpieces to be lower in strength when the outward section of resinous workpieces, which are modified by means of ozone-water treatment, are exposed to high-temperature and high-humidity environments. Then, the inventors expanded the achievement to arrive at successfully completing the present invention that will be described hereinafter.

For example, a manufacturing process according to the present invention is for workpiece for electroless plating, the workpiece having a surface to be plated by means of electroless plating, and the process comprises:

an ozone-treatment step of treating a workpiece body comprising resin and having a surface by an ozone treatment, wherein the workpiece body is brought into contact with a solution comprising ozone, thereby forming a modified layer on the surface of the workpiece body; and

a superficial-layer removal step of removing a superficial layer from the resultant modified layer by applying energy onto the modified layer.

Note that the term, “electroless plating,” might be referred to as “plating” simply whenever appropriate in the present specification.

When trying to specify the process for manufacturing workpiece for electroless plating according to the present invention roughly with diagrams, it is considered to be illustrated as shown in FIG. 1. FIG. 1 illustrates how a workpiece body appears in a cross-sectional diagram, respectively, before and after the workpiece body undergoes the individual steps of the present process for manufacturing workpiece for electroless plating. For example, the present process for manufacturing workpiece for electroless plating comprises the following two steps: (1) an ozone-treatment step in which a modified layer is formed on a surface of a workpiece body that comprises resin; and (2) a superficial-layer removal step in which a section of the resultant modified layer (or a superficial layer thereof) that is formed on the workpiece body's surface is removed. Moreover, the resultant workpiece can be further subjected to the following step: (3) an electroless-plating step in which electroless plating is performed onto the workpiece that has the modified layer with the superficial layer removed, for instance. The superficial layer of the modified layer, or a section thereof, which is to be removed in the superficial-layer removal step (2), is a part that might possibly make a starting point of come-off electroless-plating coated film in high-temperature and high-humidity environments. Since such a superficial layer is removed from the modified layer prior to the electroless-plating step (3), the resulting electroless-plating coated film can be upgraded in terms of adhesion strength. Moreover, note that only the superficial layer is removed from the modified layer in the superficial-layer removal step (2). As a result, metallic ions are likely to be deposited or precipitated in the pores that the modified layer has to result in forming a mixture layer of resin and metal when the thus manufactured workpiece for electroless plating is subjected to the electroless-plating step (3). Accordingly, it is predictable or expectable that the resulting mixture layer can demonstrate an anchoring effect on nanometer level. Consequently, it is believed that the workpiece body and electroless-plating coated film exhibit adhesion strength, which can be maintained highly, at the boundary face or interface.

Note that it is possible to daringly designate a term, “high-temperature (or high temperatures),” being 50° C. or higher, or even being 85° C. or higher, in the present specification. Moreover, in the present specification, it is possible to daringly indicate another term, “high-humidity (or high humidities),” being 60% or more, or even being 85% or more, by relative humidity.

Moreover, since the superficial layer is removed from the surface of the modified layer by applying energy onto the surface, the workpiece body can be kept being flat. In addition, the removal of the superficial layer progresses as the molecular chains of resin that makes the workpiece body is cut off or cleaved by the energy application. Such a cleavage of the molecular chains does not depend on the types of the resin. In this instance, since polar groups are formed on the surface of a completed workpiece that is adapted for electroless plating, the adhesion strength between the resultant workpiece and an electroless-plating coated film can be improved. Moreover, it is easy to change the thickness of the superficial layer to be removed depending on the thickness of the modified layer, because it is possible to adjust the thickness of the superficial layer by controlling the amount of the energy to be applied (that is, by controlling the electric power to be applied when using a plasma, for instance).

Note that a term, “flatness,” can be daringly specified in the present specification as follows: the workpiece body exhibits a surface roughness of Rz 3 μm or less, or Rz 1 μm or less, by ten-point average surface roughness according to Japanese Industrial Standard (or JIS). On the other hand, when subjecting the workpiece body to chemical etching to roughen the surface in order to produce a macro anchoring effect, the surface roughness of the workpiece body can be set to Rz 5 μm or more by ten-point average roughness in general.

In the manufacturing process for workpiece being adapted for electroless plating according to the present invention, it is preferable that the modified layer can have a thickness of from 30 to 200 nm. When the modified layer is formed in a thickness that belongs in such an appropriate range, adhesion strength can be produced sufficiently between the finished resinous workpiece and a subsequently-formed electroless-plating coated film even high-temperature and high-humidity environments. Note that it is more preferable that the thickness of the modified layer can be from 60 to 200 nm, or from 90 to 150 nm.

Moreover, in the manufacturing process for workpiece being adapted for electroless plating according to the present invention, it is preferable that the superficial layer can be removed in a thickness of from 0.1“T” or more to 0.5“T” or less from a surface of the modified layer when the resultant modified layer has a thickness “T” in the superficial-layer removal step. In this instance, note that the units of the thickness “T” can be “nm,” for instance. When the superficial layer is removed in a thickness that belongs in such a proper range, the resultant modified layer can demonstrate an anchoring effect on nanometer level as well while keeping exhibiting maintained strength, even if it has undergone high-temperature and high-humidity environments. Note that it is more preferable that the removed superficial-layer thickness can be from 0.2“T” to 0.4“T” nm, or from 0.25“T” to 0.35“T” nm, when the resultant modified layer has a thickness “T” nm.

In addition, in the manufacturing process for workpiece being adapted for electroless plating according to the present invention, it is preferable that the energy can be applied onto the resultant modified layer by means of plasma bombardment in the superficial-layer removing step. Since it is possible to make use of existing plasma generating apparatuses for the plasma bombardment or irradiation, it is possible to carry out the superficial-layer removing step readily. The application of plasma energy results in cutting off or cleaving the molecular chains in the outward face of the workpiece body. Note that it is especially preferable to use an oxidizing plasma in the plasma bombardment or irradiation. Moreover, it is further preferable that the oxidizing plasma can comprise an oxygen gas. If so, it is possible to remove the superficial layer satisfactorily by means of oxidation in the superficial-layer removing step.

The manufacturing process for workpiece being adapted for electroless plating according to the present invention makes it feasible to improve the decline of adhesion strength between resinous workpiece and electroless-plating coated film that might occur in high-temperature and high-humidity environments.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms apart of the disclosure.

FIG. 1 is a schematic diagram for illustrating an outline of a process according to the present invention for manufacturing workpiece that is adapted for electroless plating.

FIG. 2 is a bar graph for showing adhesion strength that a conventional electroless-plating coated member exhibited initially, and another adhesion strength that it exhibited after being left in a high-temperature and high-humidity environment.

FIG. 3 is a photograph that substitutes for a diagram for illustrating a cross-sectional face of a conventional electroless-plating coated member, and another photograph that substitutes for another cross-sectional face of the conventional electroless-plating coated member from which the electroless-plating coated film come off after being left in a high-temperature and high-humidity environment.

FIG. 4 is a bar graph for showing surface strengths that a resinous workpiece being not subjected to any treatment and a resinous workpiece being subjected to an ozone-water treatment exhibited initially, and other surface strengths that they exhibited after being left in a high-temperature and high-humidity environment.

FIG. 5 is a line graph for illustrating the changes of adhesion strength that the following electroless-plating coated members exhibited after being left in a high-temperature and high-humidity environment: an electroless-plating coated member being made using a conventional electroless-plating workpiece that was prepared by subjecting a resinous workpiece to an ozone-water treatment alone; and another electroless-plating workpiece being made using an electroless-plating workpiece according to the present invention that was prepared by subjecting an identical resinous workpiece to an ozone-water treatment followed by an ultraviolet-ray irradiation treatment.

FIG. 6 is a bar graph for comparing a thickness of a mixture layer in an electroless-plating coated member, which was made using a conventional electroless-plating workpiece that was prepared by subjecting a resinous workpiece to an ozone-water treatment alone, with that in an electroless-plating workpiece, which was made using another electroless-plating workpiece according to the present invention that was prepared by subjecting an identical resinous workpiece to an ozone-water treatment followed by an ultraviolet-ray irradiation treatment.

FIG. 7 is a line graph for illustrating the changes of adhesion strength that the following electroless-plating coated members exhibited after being left in a high-temperature and high-humidity environment: an electroless-plating coated member being made using a conventional electroless-plating workpiece that was prepared by subjecting a resinous workpiece to an ozone-water treatment alone; and another electroless-plating workpiece being made using an electroless-plating workpiece according to the present invention that was prepared by subjecting an identical resinous workpiece to an ozone-water treatment followed by a plasma irradiation treatment.

FIG. 8 is a bar graph for illustrating relationships between the types and irradiation times of plasma, that is, oxidizing plasma or nitrous plasma with which a resinous workpiece being subjected to an ozone-water treatment was irradiated to prepare electroless-plating workpieces according to the present invention, and adhesion strengths that were exhibited by the resulting electroless-plating coated members that were made using the present electroless-plating workpieces.

FIG. 9 is a line graph for illustrating the changes of adhesion strength that were exhibited by electroless-plating coated members, which were made using electroless-plating workpieces that were prepared by subjecting a resinous workpiece to an ozone-water treatment followed by an ultraviolet-ray irradiation treatment under various irradiation conditions, before and after they were left in a high-temperature and high-humidity environment for a long period of time.

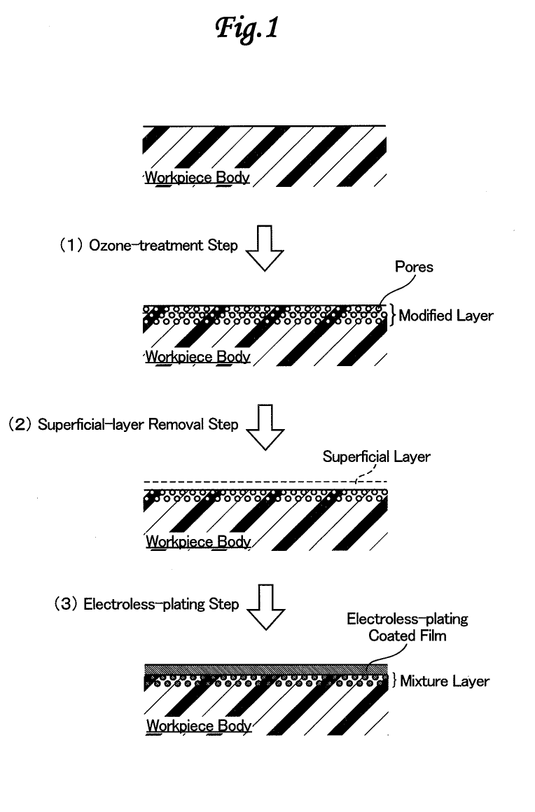

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

Hereinafter, preferable modes will be described, preferable modes which embody a process for manufacturing workpiece being adapted for electroless plating according to the present invention. Note that the numerical designations, namely, “from ‘x’ to ‘y’” as set forth in the present specification, involve the lower limit, “x,” and the upper limit, “y,” within the ranges unless otherwise specified. Moreover, it is possible to make optional numerical ranges by combining any two of numerical values that include numerical values, which are given in examples being described below, as well as the above-mentioned upper limit values and lower limit values.

A process according to the present invention for manufacturing workpiece, which is adapted for electroless plating, includes an ozone-treatment step and a superficial-layer removal step primarily. The “workpiece” (hereinafter may be referred to as an “electroless-plating workpiece” whenever appropriate) indicates resinous workpieces that are subjected to electroless plating, and that are to be provided with a plating coated film on the surface. Each of the constituent steps will be described hereinbelow.

The ozone-treatment step comprises a step of forming a modified layer on a surface of a workpiece body being made of resin by brining the workpiece body into contact with a solution containing ozone. It is possible to form the workpiece body from various resins, that is, it is possible to use thermoplastic resins, thermosetting resins and mixtures of the two for forming the workpiece. As for the thermosetting resins, it is possible to give the following: epoxy resins, cyanate resins, phenol resins, melamine resins, urea resins, unsaturated polyester resins. As for the thermoplastic resins, it is possible to exemplify the following: polyethylene resins, polypropylene, polystyrene, acrylonitrile-butadiene-styrene (or ABS) resins, acrylonitrile-styrene (or AS) resins, polyacetal resins, polyester resins, polyether resins, polyimide resins, polyamide-imide resins, polyether-imide resins, polysulfone resins, polyether-sulfone resins, polyphenylene-ether resins, polycarbonate resins, polyetheretherketone resins, and polyester resins. Among these, the manufacturing process according to the present invention can exert its advantageous effects most greatly to epoxy resins, cyanate resins, cycloolefin resins and polyimide resins that are likely to exhibit remarkably lowered adhesiveness to plating coated films in high-temperature and high-humidity environments. Moreover, it is allowable as well to form the workpiece body from composite materials that are made by adding inorganic fillers to the above-mentioned resins.

The workpiece body can have any shapes with no limitations whatever. As for the workpiece body, it is possible to use those that are formed as predetermined shapes by press molding, injection molding, and blow molding, for instance. Note that, when it is desired to carry out the ozone-treatment step and/or the superficial-layer removal step onto the workpiece partially, it is preferable to perform masking onto the workpiece body in advance.

In the ozone-treatment step of the manufacturing process according to the present invention, although it is usually possible to use water as a solvent of the solution, it is allowable to use an organic or inorganic polar solvent as the solvent. As for the organic polar solvent, it is possible to give alcohols, organic acids, N,N-dimethylformamide, N,N-dimethylacetoamide, dimethyl sulfoxide, N-methylpyrrolidone and hexamethylphosphoramide, or mixture solvents in which alcohols, organic acids or the other organic polar solvents are mixed with water or alcoholic solvents. The alcohols can be methanol, ethanol, and isopropyl alcohol. The organic acids can be formic acid, and acetic acid. As for the inorganic polar solvent, it is possible to exemplify inorganic acids, such as nitric acid, hydrochloric acid and hydrofluoric acid.

The ozone solution can be prepared by pressurizing and then dissolving ozone in one of the aforementioned solvents. An ozone concentration in the ozone solution has influences on the thickness of the modified layer to be formed on the workpiece body's surface, and on the activation of the outward face. The effect of the surface activation can be observed if the ozone concentration is 10 ppm by mass approximately when the entire ozone solution is taken as 100% by mass. However, when the ozone concentration is 20 ppm by mass or more, or 40 ppm by mass or more, with respect to the entire ozone solution taken as 100% by mass, not only the effect of the surface activation enhances remarkably, but also it becomes feasible to process the workpiece body in a short period of time. However, when the ozone concentration is more than 100 ppm by mass with respect to the entire ozone solution taken as 100% by mass, it becomes difficult to process the workpiece body uniformly, because the ozone concentration is likely to fluctuate due to the liquid-flow nonuniformity within a bath in which the ozone solution is reserved. Consequently, it is desirable that the ozone concentration can be 100 ppm by mass or less when the entire ozone solution is taken as 100% by mass. Specifically, it is preferable that the ozone concentration can fall in a range of from 20 or more to 100 ppm by mass or less, more preferably in a range of from 40 or more to 100 ppm by mass or less, with respect to the entire ozone solution taken as 100% by mass, for instance.

Note that the higher the processing temperate in the ozone-treatment step is the greater the reaction rate becomes. However, the higher the processing temperature is the lower the solubility of ozone is. As a result, the ozone concentration becomes lower in the ozone solution. Accordingly, it is preferable that the processing temperature can fall in a range of from 10 to 40° C. Moreover, it is preferable to set the time for contacting the workpiece body with the ozone solution so as to fall in a range of from 3 to 30 minutes, though the contact time depends on the concentrations of the ozone solution, and on the types of resins that make the workpiece body. The setting for the contact time is preferable because it is unlikely to demonstrate the advantageous effects resulting from the ozone treatment when the contact time is set to less than 3 minutes, even if the ozone concentration is set to 40 ppm or more; and because the resinous workpiece body might be deteriorated when the ozone treatment is carried out for more than 30 minutes. By carrying out the ozone-treatment step under such conditions, it is possible to form the modified layer with a thickness of from 30 to 200 nm approximately.

The modified layer having a thickness of 30 nm or more is preferable, because such a modified layer provides sufficient adhesion strength between workpiece and electroless-plating coated film. Moreover, apart of plating has been often removed by etching from a workpiece that is subjected to plating, in order to give the workpiece insulating property. It is not preferable that the modified layer is thicker than 200 nm, because the resultant plating, which has gone into the modified layer that has undergone plating, might not be removed fully so that the given insulating property has lowered. Consequently, the modified layer can more preferably have a thickness of from 60 to 200 nm, or much more preferably from 90 to 150 nm.

As for a method of contacting the workpiece body with the ozone solution, the following methods are available: a method of immersing the workpiece body into the ozone solution; and a method of applying the ozone solution onto the workpiece body. The method in which the workpiece body is immersed into the ozone solution is preferable, because ozone is likely to separate from the workpiece body compared with the application by spraying. A modified layer is formed on a surface of the workpiece body by means of the ozone-treatment step. The resulting modified layer is a layer that has fine pores on the order of nanometers or less. The oxidation action by ozone in the ozone aqueous solution results in generating polar groups, such as OH groups, CO groups, COOH groups, on the modified layer's surface. Moreover, the oxidation leads to generating the polar groups on the resultant pores' surface as well.

Note that is allowable to carry out a drying step after the ozone-treatment step. The drying step is a step of removing the ozone aqueous solution that adheres to the workpiece body after the ozone-treatment step. Performing a drying step is permissible, because there are such problems that, when the ozone solution has been adhering to the workpiece body in large quantity, the ozone solution might attenuate energy to be applied in the subsequent superficial-layer removal step, or might give damages to apparatuses being used in the steps that follow. However, even when the solution comprising ozone is an aqueous solution, it is not necessarily required to increase the temperature of the workpiece body in order to dry the aqueous solution after the ozone-treatment step, because the aqueous solution dries satisfactorily by leaving it as it is naturally for 5 minutes or more.

The superficial-layer removal step is a step that follows the ozone-treatment step, and in which a superficial layer of the resultant modified layer is removed by applying energy to an outward face of the modified layer. As a specific means for the energy application, it is possible to give plasma irradiation or bombardment, ultraviolet-ray irradiation or bombardment, or laser irradiation or bombardment using YAG laser or ultraviolet-ray laser.

Using plasma irradiation makes it possible to apply greater energy to the modified layer, and thereby it is feasible to remove the superficial layer readily and in a short period of time. It is allowable to make use of techniques that have been known publicly for irradiating or bombarding the modified layer with plasma. For example, it is possible to utilize the following for the irradiation or bombardment: high-frequency excitation plasma, pulsed plasma, inverter plasma, corona discharge plasma, electron cyclotron resonance plasma, and laser excitation plasma.

The efficiency of plasma irradiation or bombardment changes while being dependent upon factors like applied voltages, discharge times, gas flow volumes, pressures within chambers, and substrate biases. For example, although it is allowable that a pressure inside the plasma irradiation chamber can either be depressurized, be set at the atmospheric pressure, or be pressurized, it is preferable to set the pressure at the atmospheric pressure from an economical viewpoint. As for an input electric powder for discharge, it is permissible to input an electric power that can sustain or maintain discharge for the plasma irradiation or bombardment.

No limitations are set to a gas being used for making plasma, but it is preferable to make use of an oxidizing plasma in the manufacturing process according to the present invention. Moreover, the oxidizing plasma can preferably comprise an oxygen gas. Accordingly, it is allowable to further add nitrogen or argon to oxygen gases, or the air, to make the oxygen gas for preparing plasma. It is preferable to carry out the plasma irradiation or bombardment in such an oxidizing atmosphere, because the polar groups are generated much more in the outward face of the modified layer.

When irradiating or bombarding the modified layer with an ultraviolet ray, the ultraviolet ray can preferably have a wavelength of 350 nm or less. Moreover, it is desirable that the ultraviolet ray can have a wavelength of 300 nm or less, or more desirably a wavelength falling in a range of from 150 to 260 nm. In addition, it is desirable to set an irradiation dose of the ultraviolet ray to fall in a range of from 8 to 22 W/cm². Moreover, it is allowable to irradiate or bombard the modified layer with the ultraviolet ray for a time period of from 1 to 40 minutes. As for a light source that can irradiate or bombard such an ultraviolet ray, it is possible to use low-pressure mercury lamps, high-pressure mercury lamps, excimer lasers, barrier discharge lamps, and microwave electrodeless discharge lamps.

Moreover, the ultraviolet-ray irradiation or bombardment can desirably be carried out in the presence of oxygen, for example, in air or in oxidizing atmospheres, because the energy that ultraviolet ray possesses facilitates the occurrence of active oxygen species and the resulting active oxygen species oxidize the modified layer and then remove the superficial layer therefrom. In addition, it is preferable to carry out the ultraviolet-ray irradiation in such an oxidizing atmosphere, because the irradiation generates the polar groups much more in the outward face of the modified layer.

Note that it is allowable to select the conditions of the above-described energy application suitably depending on the types of the workpiece body and the removal magnitudes of the superficial layer. For example, it is possible to determine a removal magnitude of the superficial layer as follows: an electroless-plating treatment is carried out onto a workpiece body which has been subjected to an ozone treatment alone. Then, the resulting electroless-plating coated member is left as it is in a testing environment, which is held under high-temperature and high-humidity conditions that simulate or are severer than those of assumed service environments, for a predetermined time. Thereafter, a peeling test is carried out. Accordingly, it is possible to predict or estimate a position that makes the starting point of destruction in a mixture layer (that is, in a modified layer) by observing the cross section of a peeled superficial layer. Consequently, in the superficial-layer removal step, it is permissible to remove the superficial layer from the modified layer by a thickness that extends from the outward face of the modified layer to the predicted position.

In the manufacturing process for workpiece being adapted for electroless plating according to the present invention, it is allowable to daringly specify a thickness of the superficial layer, which is to be removed from the modified layer in the superficial-layer removal step, for instance, definitely as follows: it is permissible to remove the superficial layer by a thickness of from 0.1“T” or more to 0.5“T” nm or less; from 0.2“T” or more to 0.4“T” nm or less; or from 0.25“T” or more to 0.35“T” nm or less; from the surface of the resulting modified layer when the modified layer has a thickness of “T” nm. Removing the superficial layer by a thickness of less than 0.1“T” nm from the surface of the modified layer is not preferable, because a mixture layer swells under high-temperature and high-pressure conditions and then the mixture layer is likely to be a starting point in the peeling of electroless-plating coated films. Accordingly, the modified layer with the superficial layer thus removed is less likely to show improved adhesion strength. On the other hand, the modified layer with the superficial layer removed by more than 0.5“T” nm from the surface is not preferable, because the modified layer is less likely to give an anchoring effect on nanometer level so that peeling becomes likely to occur at the boundary face between the workpiece body and electroless-plating coated films. In this instance, it is preferable that the modified layer can have a thickness “T” of from 30 to 200 nm; it is more preferable that the modified layer can have a thickness of from 60 to 200 nm, or from 90 to 150 nm. When the modified layer has a thickness “T” of 30 nm or more, or 60 nm or more, it becomes easy to control a thickness of the superficial layer to be removed in the superficial-layer removal step because the modified layer provides the superficial layer with a thickness belonging in a wider range that is appropriate for the removal in the superficial-layer removal step. However, the modified layer having an excessive thickness “T” is not preferable, because the superficial layer should be removed by a greater thickness so that the superficial layer might not be removed fully in the superficial-layer removal step. To specify a thickness of the superficial layer to be removed more definitely, it is allowable that the superficial layer can be removed by a thickness of from 10 to 50 nm, from 20 to 40 nm, or from 25 to 35 nm, from the surface of the resultant modified layer when the modified layer has a thickness of 100 nm approximately (that is, from 90 to 110 nm, for instance).

The manufacturing process for workpiece being adapted for electroless plating according to the present invention produces electroless-plating workpieces that are subjected to electroless-plating processes. Hereinafter, descriptions will be made on one of the preprocessing steps prior to electroless-plating process that is performed onto the electroless-plating workpieces, and one of the electroless-plating processing steps that follow the preprocessing step, for instance.

Before an electroless-plating processing step, it is desirable to carry out a surface-cleansing step of brining the electroless-plating workpieces being prepared as described above into contact with a solution that comprises an alkali component and/or surface-active agent at least. The alkali component makes the mere outward face of the modified layer, which is formed on the electroless-plating workpieces, soluble in water. That is, the alkali component exposes the polar groups much more in the outward face of the modified layer in this instance. The types of the alkaline component are not limited in particular, but it is possible to use sodium hydroxide, potassium hydroxide, and lithium hydroxide. Moreover, acting a surface-active agent on the outward face of the modified layer lowers the surface tension of plating liquids to upgrade the wettability. In the surface-cleansing step, it is allowable to make use of cleaner/conditioner solutions that have been heretofore used widely as a solution that includes an alkali component and surface-active agent. The time period for contacting a cleaner/conditioner solution with the modified layer is not limited in particular, but it is permissible to set the contacting time in a range of from 1 to 10 minutes. When the contacting time is too short, the surface-active agent might adsorb onto the exposed polar groups insufficiently. On the contrary, when the contacting time is too long, the alkali component might roughen the outward face of the modified layer. In addition, the higher the temperature for contacting them is the more feasible it is to shorten the contacting time, but it is satisfactory enough to set the contacting temperature in a range of from 10 to 70° C.

The electroless-plating processing step can comprise a catalyst adsorption sub-step. In the catalyst adsorption sub-step, the modified layer of the above-described electroless-plating workpieces is brought into contact with a metallic-compound solution that comprises colloids and/or ions. By carrying out this sub-step, the colloids or ions of catalytic metal adsorb onto the polar groups in the outward face of the modified layer, and moreover onto those existing in the pores. Alkaline solutions including metallic complex ions, and acidic solutions including metallic colloids have been known as the metallic-compound solution, and both of them can be used. Using an alkaline solution of metallic compound whose metallic particle diameter is small upgrades the adhesion strength of plating coated films furthermore, because the alkaline solution exhibits good permeability into the modified layer, and good dispersibility therein. Note that the catalytic metal makes a catalyst when metallic ions are deposited or precipitated by reduction in the electroless-plating processing step. Palladium (Pd), silver (Ag), and copper (Cu) have been used commonly as the catalytic metal.

In order to bring a metallic compound solution into contact with the modified layer, it is possible to use the following methods: applying the metallic compound solution onto the outward face of the modified layer; and immersing a resinous substrate being covered with the modified layer into the metallic compound solution. The metallic compound solution is permeated by means of diffusion from the outward face of the modified layer to the inside, thereby adsorbing the ions or colloids of the metallic compound onto the polar groups. Then, the ions or colloids are turned into nanometer-level microfine metallic particles by means of reduction reactions.

The electroless-plating processing step comprises a step of forming an electroless-plating coated films on the outward face of the modified layer, for instance, after the catalyst absorption sub-step. The catalytic metal that is adsorbed on the modified layer makes cores for plating metals, and plating metals deposit or precipitate onto the cores in the electroless-plating processing step. When the intended usage of the thus formed electroless-plating coated film is for printed circuit board, the coated film is usually made up of copper plating that comprises copper; however, it is allowable that coated film can be made up of nickel plating, palladium plating, gold plating, silver plating, or cobalt plating, depending on intended usages. Moreover, the nickel plating can be pure Ni plating, Ni—P plating, Ni—B plating, and Ni—W plating, for instance.

After completing the electroless-plating processing step, it is allowable to further carry out an electrolytic-plating processing step. Although electroless-plating workpieces are inappropriate for electrolytic plating because they do not exhibit conductivity, it is feasible to perform electrolytic-plating processing onto the outward face of electroless-plating coated films after subjecting the electroless-plating workpieces to the electroless-plating processing step. The conditions of the above-described outward-face cleansing step, catalyst absorption sub-step, electroless-plating processing step and electrolytic-plating processing step are not limited at all, and therefore it is possible to carry them out in the same manner as they have been done heretofore in conventional plating processes.

Electroless-plating workpieces that can be made by the manufacturing process for electroless-plating workpiece according the present invention are suitable for making printed circuit boards. Note however that, since it is needed to form wired circuits with predetermined patters when making printed circuit boards, it is allowable to first form resists, and then to carry out the various plating processes thereafter. Moreover, it is also permissible to form resists after providing the entire face with plating, and then to form predetermined wiring by means of etching.

Although the embodiment modes of the manufacturing process for electroless-plating workpiece according the present invention have been described so far, the present invention is not limited to the above-described embodiment modes. The present invention can be conducted in various modes to which modifications and improvements are performed, modification and improvements which one of ordinary skill in the art can carry out, within a range not departing from the scope of the present invention.

### EXAMPLES

Hereinafter, the present invention will be described in more detail with reference to examples of the manufacturing process for electroless-plating workpiece according the present invention.

### Example No. 1

An electroless-plating workpiece was prepared using a resinous substrate that served as a resinous body being made from resin. The resinous substrate was made from a cycloolefin polymer (or COP), and had a size of 150 mm in height, 150 mm in width and 0.1 mm in thickness. Moreover, the resulting workpiece was subjected to chemical copper plating, one of electroless-plating processes, thereby making a copper-plating coated member. The procedure of making the coated member will be detailed hereinafter.

### Ozone Processing Step

An ozone aqueous solution was prepared, and was filled in a container. Then, the resinous substrate was immersed into the ozone aqueous solution for 15 minutes in room-temperature atmosphere. Note that the ozone aqueous solution contained ozone in a concentration of 40 ppm by mass.

### Drying Step

After taking the resinous substrate from out of the ozone aqueous solution and letting it dry naturally, the resinous substrate was kept in a desiccator for 24 hours.

### Superficial-Layer Removal Step

One of the opposite surfaces of the dried resinous substrate that had undergone the ozone processing was bombarded or irradiated with an ultraviolet ray in air. In addition to a desk-top optical surface-treatment apparatus, a low-pressure mercury lamp was used in order to bombard the ozone-processed surfaces with an ultraviolet ray. The desk-top surface-treatment apparatus was “PL21-200” that was produced by SEN TOKUSHU KOHGEN Co., Ltd., and the low-pressure mercury lamp was “EUV200GS-14 (200 W)” that was produced by the same. Moreover, while fixing the shortest distance from the light source to the resinous substrate's opposite surface at 3 cm, the ultraviolet-ray irradiation was carried out with an illumination intensity of 18 W/cm² for 10 minutes, thereby removing a superficial layer from one of the ozone-processed opposite surfaces.

### Surface Cleansing Step

After subjecting the resinous substrate to the ultraviolet-ray bombardment, the resinous substrate was immersed into a commercially available cleaner/conditioner solution, which was kept at 25° C., for 5 minutes. After taking the resinous substrate from out of the cleaner/conditioner solution, the resinous substrate was washed with water.

### Catalyst Adsorption Sub-Step

After washing the resinous substrate with water, the resinous substrate was immersed into a commercially available catalytic palladium solution, which was heated to 50° C., for 5 minutes. Subsequently, the resinous substrate was immersed into a commercially available palladium-catalyst reducing solution, which was heated to 30° C., for 5 minutes, in order to reduce the palladium ions.

### Chemical Copper-Plating Processing Step

The resinous substrate to which palladium had been adsorbed was immersed into an electroless copper-plating bath that was kept warm at 25° C. Note that 10 minutes were spent to deposit or precipitate an electroless copper-plating coated film on the resinous substrate. Moreover, the thus precipitated electroless copper-plating coated film had a thickness of 0.5 μm.

### Comparative Example No. 1

Except that no superficial-layer removal step was carried out, a copper-plating coated member was manufactured in the same manner as described in Example No. 1.

### Evaluation No. 1

### Evaluation No. 1-1

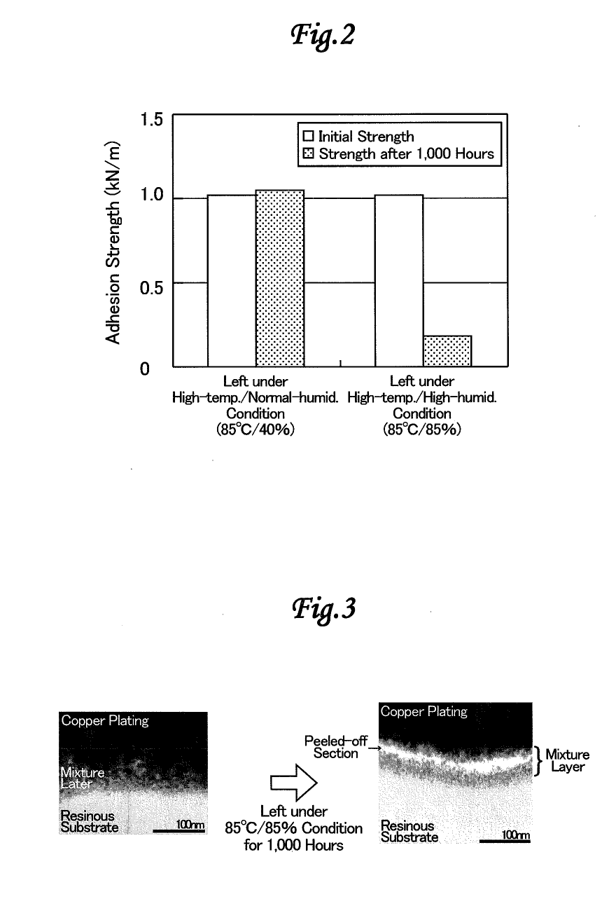

In order to show that a conventional copper-plating coated member exhibits a lowered adhesion strength between the copper-plating coated film and the resinous substrate in high-temperature and high-humidity environments, a conventional copper-plating coated member was subjected to a durability test and peeling test, thereby examining the conventional copper-plating coated member for the adhesion strength after the durability test. The adhesion strength was measured using a tensile tester (or an autograph). The coated member according to Comparative Example No. 1 was served as a test sample. Two durability tests were carried out: whereas the test sample was left in a high-temperature and high-humidity environment, whose temperature and humidity were 85° C. and 85% respectively, for 1,000 hours; the test sample was left in another high-temperature environment, whose temperature and humidity were 85° C. and 40% respectively, for 1,000 hours. Note that the “humidity” is expressed in relative humidities unless otherwise specified. The coated member according to Comparative Example No. 1 exhibited adhesion strengths before and after the durability tests as illustrated in FIG. 2.

When being subjected to the simple or mild high-temperature and normal-humidity environment, even the coated member according to Comparative Example No. 1 did not exhibit a lowered adhesion strength. However, when the coated member according to Comparative Example No. 1 was left in the higher-temperature and higher-humidity environment, it was found that the adhesion strength declined sharply. Moreover, FIG. 3 shows results of an observation in which a cross-section of the coated member according to Comparative Example No. 1 before and after being left in the higher-temperature and higher-humidity environment for 1,000 hours and then being subjected to the adhesion strength measurement (that is, the cross-section in which peeling or coming-off occurred) was observed with a transmission electron microscope (or TEM). When observing the cross section of the coated member according Comparative Example No. 1, it is possible to perceive a mixture layer between the resinous substrate and the copper-plating coated film. It is believed that the mixture layer was formed because the pores, which were present in the modified layer that was formed on the outward face of the resinous substrate, were impregnated with the copper-plating liquid. In addition, it was found that the copper-plating coated film came off beginning with the mixture layer, that is, the peeling took place starting at the mixture layer, during the durability test. Specifically, it was found that the mixture layer had exhibited an extremely lowered strength when the coated member according to Comparative Example No. 1 was left in the higher-temperature and higher-humidity environment.

### Evaluation No. 1-2

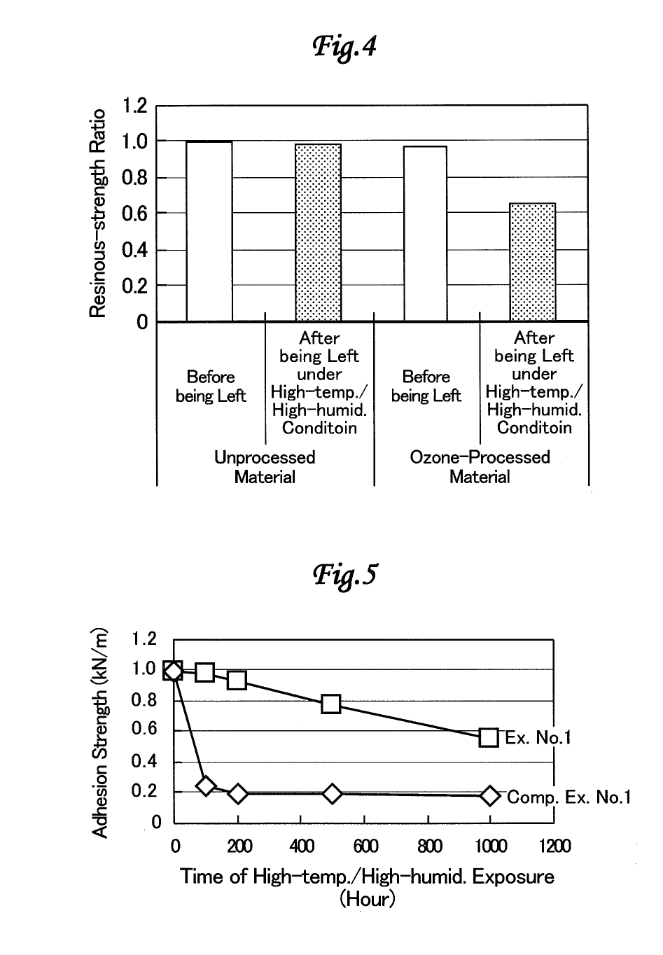

Then, a resinous substrate was subjected to a durability test. The resinous substrate was examined for shear strength in the outward face before and after the durability test. The shear strengths were measured using a constant-load mode SAICAS method (or surface and interfacial cutting method). The following were used as the test samples: an unprocessed resinous substrate (or unprocessed material) that was prior to an ozone-processing step; and another resinous substrate (or ozone-processed material) that was after the ozone-processing step but before being subjected to a superficial-layer removal step. The durability test was carried out by leaving the test samples in a high-temperature and high-humidity environment, whose temperature and humidity were 85° C. and 85% respectively, for 1,000 hours. FIG. 4 illustrates the thus measured shear strengths that the outward face of the resinous substrates exhibited before and after the durability test. Note that the shear strengths are relative values when the shear strength that the outward face of the unprocessed material exhibited before the durability test is taken as 1.

In the unprocessed material, the resinous substrate exhibited shear strengths that hardly changed before and after the durability test. However, in the ozone-processed material, the resinous substrate exhibited a shear strength, which was equivalent to that of the resinous substrate in the unprocessed material, before the durability test; however, the shear strength had lowered greatly after the ozone-processed material was left in the high-temperature and high-humidity environment. It is probable to predict that the disadvantage results from the phenomenon that the modified layer, which is formed on the outward face of the resinous substrate in the ozone-processing step, swells in environments whose temperature is high and moisture content is abundant.

### Evaluation No. 1-3

The coated member according Example No. 1, and the coated member according to Comparative Example No. 1 were subjected to a durability test that was carried out in a high-temperature and high-humidity environment in which the temperature and humidity were set at 85° C. and 85% respectively. Moreover, the coated members were held under the high-temperature and high-humidity condition for 100 hours, 200 hours, 500 hours, and 1,000 hours, respectively. Then, the thus aged coated members were examined for adhesion strength. A tensile tester (or an autograph) was used to measure the adhesion strengths. FIG. 5 illustrates results of the measurements.

When the coated member according to Comparative Example No. 1 was left in the high-temperature and high-humidity environment just for 100 hours only, it exhibited an adhesion strength that had declined considerably. On the other hand, the coated member according to Example No. 1 could maintain the adhesion strength that it exhibited before the durability test as far as it was held under the high-temperature and high-humidity condition for 200 hours approximately. Moreover, even when the durability test was carried out for a much longer period of time, the coated member according to Example No. 1 could sustain the original or initial adhesion strength by about 60% approximately.

### Evaluation No. 1-4

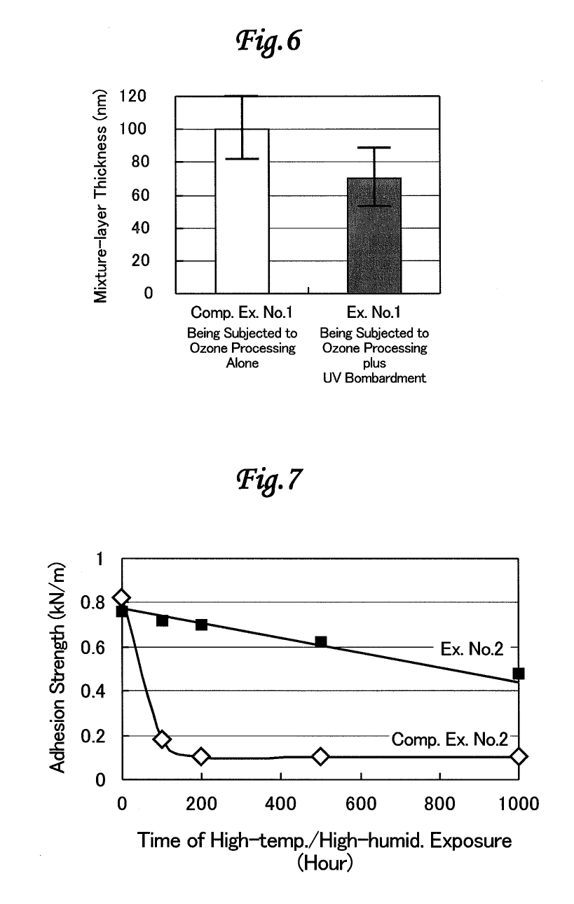

In order to calculate a thickness of the superficial layer that was removed in the superficial-layer removal step according to Example No. 1, a thickness of the mixture layer in the coated member according to Example No. 1 was compared with that of the mixture layer in the coated member according to Comparative Example No. 1. The mixture-layer thicknesses were measured at a plurality of locations in a TEM photograph on the coated member according to Example No. 1, and in another TEM photograph on the coated member according to Comparative Example No. 1. Then, the thus measured thicknesses were averaged by numbers, and the resulting number average values were taken as the mixture-layer thicknesses according to Example No. 1 and Comparative Example No. 1, respectively. FIG. 6 illustrates results of the measurements.

Since the mixture layer in the coated member according to Comparative Example No. 1 had a thickness of 100 nm, it was found that the ozone-processing step produced a modified layer having a thickness of 100 nm. Meanwhile, the mixture layer in the coated member according to Example No. 1 had a thickness of 70 nm. That is, it was understood that the superficial-layer removal step removed the superficial layer by a thickness of 30 nm from the outward face of the modified layer.

### Example No. 2

Except that the means for applying energy was changed to plasma from the ultraviolet ray that was used in the superficial-layer removal step according to Example No. 1, a copper-plating coated member according to Example No. 2 was made in the same manner as the copper-plating member according to Example No. 1. The alternative superficial-layer removal step will be described hereinafter.

### Superficial-Layer Removal Step

After drying the opposite surfaces of the resinous substrate that had undergone the ozone-processing step, an oxidizing-plasma bombardment or irradiation was performed onto one of the dried opposite surfaces. An atmospheric plasma gun was used to irradiate the opposite surface with the oxidizing plasma. Moreover, the shortest distance was fixed at 5 cm between the plasma source and the resinous substrate's opposite surface, and then the dried opposite surface of the resinous substrate was irradiated with the oxidizing plasma with an output of 0.2 W/cm² for 30 minutes. Thus, a superficial layer was removed from one of the ozone-processed opposite surfaces of the resinous substrate.

### Comparative Example No. 2

A copper-plating coated member was manufactured in the same manner as described in Example No. 2 other than that the superficial-layer removal step using the oxidizing plasma was not carried out.

### Evaluation No. 2

The coated member according Example No. 2, and the coated member according to Comparative Example No. 2 were evaluated for adhesion strength after being subjected to a durability test. The durability test was carried out by holding the coated members in a high-temperature and high-humidity environment for 100 hours, 200 hours, 500 hours, and 1,000 hours, respectively. Then, the thus aged coated members were examined for adhesion strength, using a tensile tester (or an autograph). Note that the conditions of the high-temperature and high-humidity environment were set at 85° C. in temperature, and at 85% in humidity. Results of the measurements are given in FIG. 7.

As illustrated in FIG. 7, the adhesion strength had declined considerably in the coated member according to Comparative Example No. 2 that had been left in the high-temperature and high-humidity environment just for 100 hours only. On the other hand, the adhesion strength lowered gently in the coated member according to Example No. 2 even when it experienced the durability test for a much longer period of time.

### Example No. 3

Instead of the oxidizing plasma, nitrous plasma was used in the superficial-layer removal step according to Example No. 2; except the replacement of the energy application means for removing superficial layer, the same procedures as described in Example Nos. 1 and 2 were followed to make a coated member according to Example No. 3.

### Example No. 4

Except that the ozone-processed resinous substrate was bombarded or irradiated with the oxidizing plasma for 10 minutes, instead of 30 minutes, a coated member according to Example No. 4 was made in the same manner as described in Example No. 2.

### Example No. 5

Except that the ozone-processed resinous substrate was bombarded or irradiated with the nitrous plasma for 10 minutes, instead of 30 minutes, a coated member according to Example No. 5 was made in the same manner as described in Example No. 3.

### Evaluation No. 3

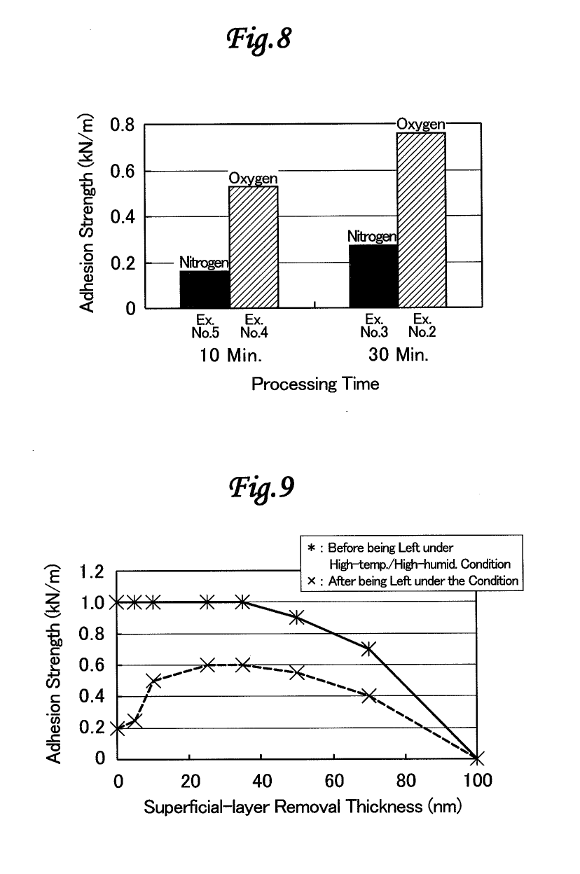

The adhesion strengths of the coated members according Example Nos. 2, 3, 4 and 5 were measured, using a tensile tester (or an autograph). Note that the measured values were the initial adhesion strengths because the coated members were not subjected to any durability tests. FIG. 8 illustrates results of the measurements.

The coated members according to Example Nos. 3 and 5, from which the superficial layers were removed using the nitrous plasma, exhibited a lower initial adhesion strength, respectively. On the contrary, the coated members according to Example Nos. 2 and 4, from which the superficial layers were removed using the oxidizing plasma, exhibited a higher initial adhesion strength, respectively. The phenomena are believed to arise as follows: the oxidizing plasma is more likely to oxide the superficial layers than the nitrous plasma is; and the oxidizing plasma produces the polar groups more in the outward face of the resinous substrate than the nitrous plasma does. Moreover, the coated member according to Example No. 2 produced an initial adhesion strength that matched for that of the coated member according to Example No. 1, because it was not only subjected to the oxidizing plasma but also underwent the oxidizing-plasma bombardment or irradiation for such a longer period of time as 30 minutes. It is believed that the advantage results from the tendency that the longer the oxidizing-plasma irradiation time is the more likely it is to form the polar groups in the outward face of the resinous substrate abundantly.

The coated members according to Example Nos. 3, 4 and 5 exhibited the lower adhesion strengths initially as described above; it should be remarked however that even the coated members according to Example Nos. 3, 4 and 5 showed adhesion strengths that were inhibited from lowering after they were subjected to durability tests in high-temperature and high-humidity environments.

### Evaluation No. 4

The thickness of the superficial layer to be removed was changed by altering the illumination intensity and/or irradiation time of the ultraviolet ray that was used in the superficial-layer removal step according to Example No. 1, and thereby the copper-plating coated member was made in seven types. Note that, other than the superficial-layer removal step, the seven coated members were prepared following the respective steps according Example No. 1. When the resulting seven coated members were observed with a transmission electron microscope (or TEM), the superficial layer was removed by a thickness of 5 nm, 10 nm, 25 nm, 35 nm, 50 nm, 70 nm and 100 nm, respectively, in the superficial-layer removal step. Note that the thickness of the removed superficial layer will be hereinafter referred to as a “removed superficial-layer thickness” whenever appropriate. Moreover, the removed superficial-layer thickness being 100 nm indicates that the entire modified layer was removed. The seven coated members were subjected to a durability test in which they were held in a high-temperature (e.g., 85° C.) and high-humidity (e.g., 85% in RH) environment for 1,000 hours. The seven coated members were examined for adhesion strength before and after the durability test. A tensile tester (or an autograph) was used to measure the adhesion strengths. FIG. 9 illustrates results of the adhesion-strength measurements. Note that, in FIG. 9, the test specimen whose removed superficial-layer thickness was 0 nm is equivalent to the coated member according to Comparative Example No. 1.

When the removed superficial-layer thickness fell in a range of from 10 to 50 nm, the after-durability-test adhesion strength did not reduce by more than 50% from the before-durability-test adhesion strength. Moreover, when the removed superficial-layer thickness fell in a range of from 25 to 35 nm, the after-durability-test adhesion strength was no less than 60% approximately of the before-durability-test adhesion strength. In view of the thickness of the modified layer being 100 nm, it was ascertained that the decline of the adhesion strength between resinous workpiece and electroless-plating coated film, which occurs in high-temperature and high-humidity environments, can be inhibited by removing the superficial layer from the modified layer by a thickness that falls in the following proportional ranges: from 10 to 50% of the modified layer's thickness, from 20 to 40% thereof, or from 25 to 35% thereof. The advantageous effect can be produced similarly even when plasmas are used in the superficial-layer removal step.

### Evaluation No. 5

In Evaluation No. 4, only the thickness of the superficial layer to be removed was changed. In Evaluation No. 5, in addition to changing the removed superficial-layer thickness, the thickness of the modified layer was further changed by altering the ozone concentration and/or immersion time in the ozone-processing step. Thus, multiple copper-plating coated members were made variously. The resulting coated members were subjected to a TEM observation to measure the thickness of the modified layers and the thickness of the removed superficial layers. Table 1 below summarizes the measured modified layer's thicknesses and the removed superficial-layer thicknesses.

A durability test was carried out in order to examine each of the copper-plating coated members being prepared as described above for the adhesion strengths before and after being held under a high-temperature and high-humidity condition, that is, at a temperature of 85° C. and in a relative humidity of 85%, for 1,000 hours. The adhesion strengths were measured using a tensile tester (or an autograph). Table 1 below gives results of the measurements. Moreover, Table 1 lists types of the workpiece bodies that were made use of herein as well.

TABLE 1

| Type of | | Removed | |
|---|---|---|---|
| Workpiece | Modified Layer's | Superficial-layer | |
| Body | Thickness “T” (nm) | Thickness (nm) | Assessment |
| COP Resin | 30 | 5 | Fair |
| | | 10 | Good |
| | | 15 | Poor |
| COP Resin | 70 | 5 | Fair |
| | | 15 | Good |
| | | 30 | Good |
| | | 50 | Poor |
| Epoxy Resin | 120 | 5 | Fair |
| | | 15 | Good |
| Epoxy Resin | 200 | 10 | Fair |

Note that the designations in Table 1 above indicate as follows. “Good” indicates that the adhesion strength after being left in the high-temperature and high-humidity testing environment was greater by 50% or more than that before being left therein was considered 100%. “Fair” indicates that the adhesion strength was not satisfactory enough after being left in the high-temperature and high-humidity testing environment. “Poor” indicates that the adhesion strength was not satisfactory enough even before being left in the high-temperature and high-humidity testing environment.

In any one of the above copper-plating coated members, the adhesion strength was upgraded by removing the superficial layer from the modified layer. However, when the removed superficial-layer thickness was too less with respect to the modified layer's thickness, the coated members exhibited an adhesion strength insufficiently after they had been left in the high-temperature and high-humidity environment. For example, when the modified layer had a thickness of 30 nm, removing the superficial layer by 10 nm approximately from the modified layer could result in obtaining coated members that showed a good adhesion strength after the durability test. Moreover, when the modified layer had a thickness that exceeded 30 nm, it was possible to manufacture coated members, which showed a good adhesion strength after the durability test, by removing the superficial layer from the modified layer by a proportion of 0.1“T” nm or more with respect to the modified-layer thickness being designated as “T” nm. In addition, an allowance or range exists in terms of the removed superficial-layer thickness that enables the resulting coated members to achieve keeping exhibiting a high adhesion strength after being left in a high-temperature and high-humidity environment, that is, an adhesion strength after high-temperature and high-humidity exposure, or aged adhesion strength, which is 50% or more of the adhesion strength prior to being held under the high-temperature and high-humidity testing condition. Specifically, it was found out that the removal amount or magnitude of the superficial layer could be controlled with ease, because the allowance or range of the removed superficial-layer thickness widened when the modified layer had a thickness of 60 nm or more, for instance.

Having now fully described the present invention, it will be apparent to one of ordinary skill in the art that many changes and modifications can be made thereto without departing from the spirit or scope of the present invention as set forth herein including the appended claims.

What is claimed is:

1. A manufacturing process for workpiece for electroless plating, the workpiece having a surface to be plated by means of electroless plating, the process comprising:
an ozone-treatment step of treating a workpiece body comprising resin and having a surface by an ozone treatment, wherein the workpiece body is brought into contact with a solution comprising ozone, thereby forming a modified layer on the surface of the workpiece body; and
a superficial-layer removal step of removing a superficial layer from the resultant modified layer by applying energy onto the modified layer.

2. The manufacturing process according to claim 1, wherein the superficial layer is removed in a thickness of from 0.1“T” or more to 0.5“T” or less from a surface of the modified layer when the resultant modified layer has a thickness “T” in the superficial-layer removal step.

3. The manufacturing process according to claim 2, wherein the modified layer being formed in the ozone-treatment step has a thickness of from 30 to 200 nm.

4. The manufacturing process according to claim 1, wherein the energy is applied onto the resultant modified layer by means of plasma bombardment in the superficial-layer removal step.

5. The manufacturing process according to claim 4, wherein an oxidizing plasma is used in the plasma irradiation.

6. The manufacturing process according to claim 5, wherein the oxidizing plasma comprises an oxygen gas.

7. The manufacturing process according to claim 1, wherein the superficial-layer removal step is carried out by means of ultraviolet-ray irradiation.

8. The manufacturing process according to claim 2, wherein the modified layer has a thickness of from 60 to 200 nm.
